(19) United States
(12) Patent Application Publication
(10) Pub. No.: US 2003/0135323 A1
(43) Pub. Date: Jul. 17, 2003

(54) Method and device for operating a motor vehicle engine

(75) Inventors: Martin Votsmeier, Maintal (DE); Tassilo Bog, Munchen (DE); Dieter Lindner, Hanau (DE); Jurgen Gieshoff, Biebergemund (DE); Egbert Lox, Hochwaldhausen (DE); Thomas Kreuzer, Karben (DE)

Correspondence Address: KALOW & SPRINGUT LLP, 488 MADISON AVENUE, 19TH FLOOR, NEW YORK, NY, 10022, US

(73) Assignee: OMG AG & Co. KG, Hanau (DE)

(21) Appl. No.: 10/305,228

(22) Filed: Nov. 26, 2002

(30) Foreign Application Priority Data
Nov. 28, 2001 (DE) 10158480.6-26

(51) Int. Cl. F02D 45/00; F02D 41/02

(52) U.S. Cl. 701/115; 701/106

(57) ABSTRACT

The present invention is directed to a method and device for operating an engine of a motor vehicle. Firstly, driving condition parameters of the engine and/or the motor vehicle are collected over a predetermined period of time. After that the probabilities of parameters for the future operation of the engine in relation to the captured driving condition parameters are ascertained. Finally, operating parameters of the engine are adjusted in relation to the ascertained probability values for the parameters.

### FIELD OF THE INVENTION

The present invention relates to a method and device for operating an engine of a motor vehicle where such motor vehicles are passenger cars and trucks and have Otto engines or diesel engines.

### BACKGROUND OF THE INVENTION

In order to optimize the efficiency and in particular fuel consumption of engines, control systems for such engines are controlled in an appropriate manner. In particular, such engine systems exhibit exhaust gas treatment systems by means of which a cleaning step of the exhaust gas is carried out to reduce the emissions of these engines.

Such exhaust gas treatment systems make use of catalytic treatment of the exhaust gases by contacting them with an exhaust gas catalyst in order to convert the hazardous exhaust gas components into harmless compounds. An example of such exhaust gas catalysts are so-called three-way catalysts by means of which most part of the emission of the exhaust gas, in particular carbon monoxide (CO), non-burned hydrocarbons (HC) and nitrogen oxides (NOₓ) can be removed simultaneously.

Such three-way catalysts are especially used for the exhaust emission control of Otto engines, which are operated stoichiometrically. Stoichiometric operation is defined by a value of the normalized air/fuel ratio ë=1. The normalized air/fuel ratio ë is the actual air/fuel ratio divided by the air/fuel ratio for stoichiometric conditions.

In modern motor vehicles, also so-called lean burn engines are used to reduce the fuel consumption. These engines are diesel engines or also Otto engines which are operated with lean air/fuel mixtures. Contrary to engines operated at stoichiometry, even greater problems occur during cleaning the exhaust gas of such lean burn engines. During most of their operation time, these engines operate with normalized air/fuel ratios ë greater than 1.3. Their exhaust gas contains about 3 to 15 vol.-% oxygen.

Thus, there are highly oxidizing conditions in the exhaust gas of lean burn engines. With high oxidizing conditions, nitrogen oxides in the exhaust gas can no longer be easily converted into harmless nitrogen.

In order to solve this problem, so-called nitrogen oxides storage catalysts have been developed as further exhaust gas treatment systems which oxidize the nitrogen oxides to nitrogen dioxide under lean exhaust conditions and store it in form of nitrates. After having reached the storage capacity of the catalyst, it is regenerated. This is done by enriching the exhaust gas and, if necessary, by increasing the exhaust gas temperature. Thus, the stored nitrates are decomposed and supplied into the exhaust gas stream as nitrogen oxides. The released nitrogen oxides are then reduced to nitrogen in the storage catalyst by oxidation of the reductive components (hydrocarbons, carbon monoxide and hydrogen) contained in the rich exhaust gas. Thus, the storage catalyst regains its original storage capacity. Such storage cycle approximately takes 60 to 100 seconds, wherein the regeneration takes about 0.5 to 20 seconds. The successions of the storage and regeneration cycles form further operating parameters for operating the engines.

The content of sulfur oxides in the exhaust gas represents a substantial obstacle to the use of nitrogen oxides storage catalysts since they, too, are oxidized in the storage catalyst under lean exhaust gas conditions and react with the storage components to form thermally very stable sulphates which cannot be destroyed during the normal regeneration of the storage catalyst. Thus, the storage capacity of the storage catalyst decreases with increasing life as the storage components are blocked by sulphates.

In order to decrease such contaminations of nitrogen oxides storage catalysts, a sulfur trap is arranged before the nitrogen oxides storage catalyst in the exhaust gas stream of the engine. This combination of sulfur trap and nitrogen oxides storage catalyst is operated such that under lean exhaust gas conditions, sulfur oxides are stored in the sulfur trap and the nitrogen oxides in the nitrogen oxide storage catalyst. By periodically changing the exhaust gas conditions from lean to rich, the sulphates stored in the sulfur trap are decomposed to sulfur dioxide and the nitrates stored in the nitrogen oxides storage catalysts are decomposed to nitrogen dioxide.

Alternatively, for the purpose of sulfur removal from the sulfur trap, provision can be made for increasing the exhaust gas temperature to values, which are above the limiting temperature of the storage catalyst for storing of nitrogen oxides. The succession of the sulfur removal processes is a further operating parameter for the operation of engines in motor vehicles. The dependence on time of the operating parameters of the control of such engines and their exhaust treatment systems essentially determines the fuel consumption and the exhaust emission of these vehicles.

An example of this is the sulfur removal from nitrogen oxides storage catalysts. While removing sulfur, substantial amounts of sulfur dioxide are emitted for a short period of time. Such a removal of sulfur is preferably carried out during full load operation, i.e. in particular during motorway drives since in this situation, the increased temperature of the catalyst system necessary for the removal of sulfur can be achieved with minimal energy use.

Further examples of this is the operation of three-way catalysts in Otto engines or the regeneration of diesel soot particulate filters that have to be regenerated in predetermined intervals.

Based on the forgoing, there is a need in the art for a process for optimizing operating parameters relevant to the operation of engines in motor vehicles as to time in order to achieve optimal efficiency of the exhaust gas treatment system and optimal fuel consumption at the same time.

### SUMMARY OF THE INVENTION

The method for operating the engine of a motor vehicle according to the invention exhibits the following steps. Firstly, the driving condition parameters of the engine and/or the vehicle are collected over a predetermined period of time. Further, the probabilities of parameters for the future operation of the engine are determined dependent on the collected driving condition parameters. Finally, the operation parameters of the engine are determined dependent on the probability values of the parameters.

Thus, the underlying idea of the invention is to collect the driving conditions of the motor vehicle and the engine over a longer period of time. The data collection can be done with a computer. For example, the driver's driving habits are identified, i.e. whether regularly the same trips with certain routes, speeds or acceleration habits are made. Preferably, navigation signals are read in by external navigator systems such as GPS systems to additionally determine the geographical position of the motor vehicle. Furthermore, control signals of external computer and control units, especially traffic lights or other kinds of traffic control systems can be ascertained as driving condition parameters.

For a better understanding of the present invention together with other and further advantages and embodiments, reference is made to the following description taken in conjunction with the examples, the scope of which is set forth in the appended claims.

### BRIEF DESCRIPTION OF THE DRAWING

Preferred embodiments of the invention have been chosen for purposes of illustration and description, but are not intended in any way to restrict the scope of the invention. The preferred embodiments of certain aspects of the invention are shown in the accompanying figure, wherein:

FIG. 1 illustrates a block diagram of an example of the device for controlling the operation of a motor vehicle's engine.

### DETAILED DESCRIPTION OF THE INVENTION

The invention will now be described in connection with preferred embodiments. These embodiments are presented to aid in an understanding of the present invention and are not intended to, and should not be construed to, limit the invention in any way. All alternatives, modifications and equivalents, which may become obvious to those of ordinary skill on reading the disclosure are included within the spirit and scope of the present invention.

This disclosure is not a primer on methods for process for optimizing operating parameters relevant to the operation of engines in motor vehicles, basic concepts known to those skilled in the art have not been set forth in detail.

According to the invention, the ascertained driving habit is used in the computer unit to calculate probabilities of certain parameters, where operating parameters of the engine are adjusted in relation thereto to optimize the fuel consumption and emission.

This means that by the probability calculations, information is gathered about the future performance of the motor vehicle, and the operation parameters are accordingly adjusted thereto. Via a correspondingly comprehensive and exact analysis of the current performance, the dependence on time of the operating parameters can be optimized with high reliability by means of appropriate evaluation systems such as fuzzy logic systems or neuronal networks.

The examples are working example of the device according to the invention for removing soot particles from the exhaust gas from a diesel engine. A first example for such optimization is the sulfur removal process in nitrogen oxides storage catalysts. According to the invention, the removal of sulfur is not carried out within fixed predetermined intervals. Rather, the moments of the sulfur removal form operation parameters that are carried out in relation to the probability calculations for the relevant parameters conducted in the computer unit. In this case, the parameters are made up of the speed and acceleration profiles as well as preferably of the geographical positions of the motor vehicles. On the basis of the evaluation of the driving condition parameters corresponding to the parameters, it can for example be found out whether the motor vehicle is regularly used for motorway drives. With this information, the probabilities for the time intervals in which future motorway drives take place are calculated in the computer unit. On the basis of these parameters, the time for the removal of sulfur of the nitrogen oxide storage catalyst is timed such as to take place during the intervals of the expected future motorway travels.

Thus, the removal of sulfur from the nitrogen oxides storage catalyst is carried out with high probability while driving on motorways and not in the town traffic. Therefore, the temperature of the catalyst system necessary for removing sulfur is achieved with minimal use of energy.

A further example of the present invention is the optimized operation of three-way catalysts. By means of the device according to the invention, the control of the normalized air/fuel ratio ë of the three-way catalyst can be optimized.

A further example of the present invention is the optimized operation of diesel exhaust particulate filters, which are especially used for removing particulates in exhaust gas of diesel engines. Such diesel exhaust particulate filters have to be regenerated at certain time intervals. By the device according to the invention, the intervals are selected such, that with high probability, the regeneration of the diesel exhaust particulate filters can be carried out during full load operation wherein already high temperatures of the diesel exhaust particulate filter prevail so that it can be regenerated with low use of energy.

Having now generally described the invention, the same may be more readily understood through the following references to the following examples, which are provided by way of illustration and are not intended to limit the present invention unless specified.

### EXAMPLES

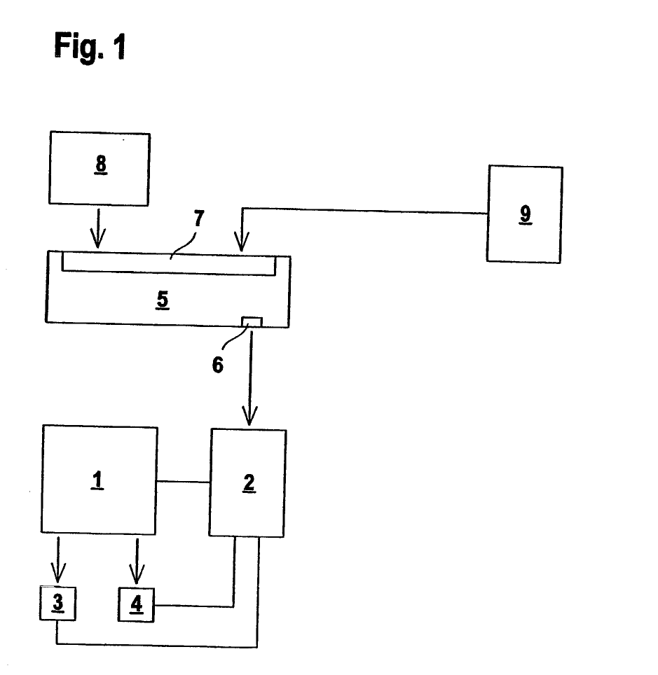

The invention is described in more detail in FIG. 1 and the following examples:

FIG. 1 schematically shows an engine 1 of a motor vehicle being controlled by a control 2. The engine 1 is a lean burn Otto engine, i.e. the engine 1 is operated at normalized air/fuel ratios ë>1, preferably, e.g. at ë=1.3. An exhaust gas treatment system is assigned the engine 1 which serves the cleaning of the exhaust gas of the engine 1. The exhaust treatment system comprises a three-way catalyst 3 and a nitrogen oxides storage catalyst 4. The operation of the exhaust treatment system, too, is controlled via the control 2.

A computer unit 5, which displays a microprocessor system not shown in FIG. 1, is arranged before the control 2 of the engine 1. The computer unit 5 controls the control 2 of the engine 1 via output signals, which are inputted in the control 2 via an output 6 of the computer unit 5.

At the input side, the computer unit 5 is provided with an interface unit 7 for reading in signals into the microprocessor system. These signals are both internal signals, generated within the motor vehicle and external signals, generated outside the motor vehicle, the signals being evaluated as driving condition parameters in the computer unit 5.

The internal signals are generated or collected in an on-board computer 8 or the like in the motor vehicle and then read in into the computer unit 5. These internal signals are particularly determined by the current speed and the acceleration of the vehicle. Further, the routes covered by the motor vehicle in certain intervals of time are read in into the computer unit 5 as internal signals.

In the present case, the external signals are formed by navigation signals that are read in into the computer unit 5 by a navigator system 9. The navigator system 9 is particularly a GPS system, the control signals forming the current geographical position of the vehicle.

Alternatively or in addition, the external signals can be control signals, which are read in into the computer unit 5 by external computer and/or control units. Such external units may be traffic control systems, on-board computers 8 of other vehicles or traffic lights. The control signals transmitted by these units via suitable transmitter/receiver systems contain especially advantageously information about the current volume of traffic and generally serve the control 2 of the traffic flow.

In the computer unit 5, the driving condition parameters are continuously registered whereby the performance of the motor vehicle is completely gathered over a defined period of time. These driving condition parameters provide input quantities for the calculation of probabilities of parameters for the future performance of the vehicle.

Preferably, the probability calculation of the parameters is carried out via a fuzzy logic system that is implemented in the computer unit 5. As an alternative thereto, a neuronal network can be provided. The parameters are in particular made up of route, speed and/or acceleration profiles.

By the fuzzy logic system, it is particularly registered whether certain routes are regularly used by the motor vehicle with certain speed and/or acceleration profiles. In particular, on the basis of the input quantities of the fuzzy logic system, it is found out at which time of the day and on which days of the week the motor vehicle is driven particularly often at low speed in town traffic or at high speed at motorways. The thus formed input quantities typically exhibiting a certain fuzziness are evaluated in a known manner with a system of fuzzy logic rules so that as output quantities the probabilities of the parameters for the future performance are obtained.

In the computer unit 5, the output signals with which the control 2 of the engine 1 is controlled are derived from these parameters. The output signals are generated such that the operating parameters of the engine 1, in particular the operating parameters of the exhaust treatment system are predetermined dependent on time according to the expected performance of the motor vehicle such that the fuel consumption and/or the exhaust emission of the motor vehicle is minimized.

As regards the exhaust treatment system according to FIG. 1, examples for such operating parameters are the moments of regeneration and of the removal of sulfur from the nitrogen oxide storage catalyst 4.

The removal of sulfur from a nitrogen oxide storage catalyst 4 is preferably carried out during a motorway trip of the motor vehicle since then the removal of sulfur can be executed with minimal use of energy compared to the higher temperature of the catalyst system during town traffic. In the computer unit 5, it is, especially determined by means of the probability calculations of the parameters on the basis of predetermined probabilities when a vehicle is expected to be used for motorway trips. Via the output signal, a due removal of sulfur from the nitrogen oxide storage catalyst is delayed until with high probability the next motorway trip starts.

One embodiment of the present invention provides an engine management system that estimates the route the driver will take in the future and uses this information to optimally control the operation of the exhaust system. It is preferred that the driver enters his or her destination into the navigation system and follows the directions of the navigation system.

Another embodiment of the present invention provides that a particular filter regeneration or NOx trap desulphurisation should not be started if the system detects that the driver is approaching a traffic jam or a speed limit. This control system obtains some information via communication with surrounding computer systems. These signals can also be from toll charging systems or any other electronic device in other vehicles that communicates directly or indirectly with the engine control computer.

While the invention has been described in connection with specific embodiments thereof, it will be understood that it is capable of further modifications and this application is intended to cover any variations, uses, or adaptations of the invention following, in general, the principles of the invention and including such departures from the present disclosure as come with the known or customary practice within the art to which the invention pertains and as may be applied to the essential features hereinbefore set forth and as follows in the scope of the appended claims.

What is claimed:

1. A method for operating an engine of a motor vehicle, the method comprising the following steps:
collecting vehicle driving condition parameters of the engine and/or the motor vehicle over a predetermined period of time to determine the vehicle driving condition parameters;
determining probabilities of parameters for the future operation of the engine based on the determined driving condition parameters; and
adjusting operating parameters of the engine according to the determined probability values for the parameters.

2. A method according to claim 1, wherein the driving condition parameters are determined by the distances of routes covered by the motor vehicle and/or the respective speed and/or acceleration profiles.

3. A method according to claim 1, wherein the driving condition parameters comprise navigation signals read by an external navigator system.

4. A method according to claim 1, wherein the driving condition parameters read in by external computer and/or control units are control signals.

5. A method according to claim 4, wherein the computer and/or control units are traffic control systems, traffic lights or electronic navigators of other motor vehicles.

6. A method according to claim 1, wherein the probabilities of the parameters describe the performance to be expected of the motor vehicle.

7. A method according to claim 6, wherein the route, speed and/or acceleration profiles to be expected constitutes the parameters.

8. A method according to claim 1, wherein the operating parameters are adjusted parameters of the control of the engine.

9. A method according to claim 1, wherein the operating parameters are adjusted parameters for influencing an exhaust treatment systems.

10. A method according to claim 9, wherein a diesel exhaust particulate filter is used as the exhaust treatment system, the moments of the regeneration of the diesel exhaust particulate filter being adjusted as parameters.

11. A method according to claim 9, wherein a three-way catalyst is used as an exhaust treatment system, the air ratio of the three-way catalyst being controlled in relation to the parameters.

12. A method according to claim 9, wherein a nitrogen oxide storage catalyst is provided as an exhaust treatment system, which is regenerated in predetermined intervals in relation to the parameters.

13. A method according to claim 12, wherein the sulfur is removed from the nitrogen oxide storage catalyst dependent on the parameters in predetermined intervals.

14. A method for operating an engine of a motor vehicle, comprising:
a means for collecting driving condition parameters of the engine and/or the motor vehicle;
a computer unit for ascertaining probabilities of parameters for future operation of the engine in relation to vehicle condition parameters; and
a means for adjusting operating parameters of the engine in relation to the ascertained probability values for the parameters.

15. A method according to claim 14, wherein the computer unit comprises an interface unit for reading internal and external signals.

16. A method according to claim 15, wherein the internal signals are formed from the motor vehicle's current speed and acceleration profiles.

17. A method according to claim 15, wherein the external signals are formed from navigation signals generated in navigator systems and/or control signals generated in external computer and/or control units.

18. A method according to claim 14, wherein a fuzzy logic system or a neuronal network for ascertaining the parameters is integrated into the computer unit.

19. A method according to claim 14, wherein in the computer unit, output signals are generated by means of which the control of the engine is effected.

20. A method according to claim 19, wherein the control of the engine has an exhaust treatment system.

21. A method according to claim 20, wherein the exhaust treatment system has a three-way catalyst.

22. A method according to claim 20, wherein the exhaust treatment system has a nitrogen oxide storage catalyst.

23. A method according to claim 20, wherein the exhaust treatment system has a diesel exhaust particulate filter.
